(19) United States
(12) Patent Application Publication
(10) Pub. No.: US 2006/0227348 A1
(43) Pub. Date: Oct. 12, 2006

(54) Information processing method and apparatus

(76) Inventor: Fumiaki Takahashi, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/397,819

(22) Filed: Apr. 4, 2006

(30) Foreign Application Priority Data
Apr. 8, 2005 (JP) 2005-112656(PAT.)

(51) Int. Cl. G06K 9/00

(52) U.S. Cl. 358/1.9; 358/518; 382/167

(57) ABSTRACT

A visualized image visually indicating the content of change in an image in a case that an image processing parameter is used is generated based on the set image processing parameter. The image processing parameter is associated with the generated visualized image and stored as e.g. one image file into a memory.

### FIELD OF THE INVENTION

The present invention relates to storage of image processing parameter used in digital image data processing.

### BACKGROUND OF THE INVENTION

Generally, an image obtained by image sensing with a digital camera can be browsed by an image browser installed in a personal computer. Otherwise, the image can be subjected to image editing with image editing software on the personal computer. Generally, in image editing, image processing is performed on a source image using an image processing parameter such as an image processing table and a result image is obtained.

As a more particular example, image processing (image editing) such as color change processing or edge emphasizing processing on an image obtained by image sensing with an image input device such as a digital camera by application software or the like on a personal computer. In this manner, an image having desired color tint can be obtained by execution of such processing, or a sharp image by edge emphasizing, or a blurred image, can be obtained from an image obtained by image sensing.

Generally, upon the above image editing, to obtain a user's desired result image, it is necessary for the user to select an optimum image processing parameter (see Japanese Patent Application Laid-Open No. 2000-231624).

However, for users unaccustomed to image processing, it is difficult to select an optimum image processing parameter. Regarding an image processing parameter for generally-known image processing effect (high/low contrast or the like), the users can make a selection when they become accustomed to image processing to a certain degree. However, even users who accustomed to image processing have difficulty in selection of optimum parameter in image processing regarding which the content of table is unknown.

Accordingly, it may be arranged such that once-generated image processing parameter is stored for reuse in the future. To meet such requirement, it has been proposed to name an image processing parameter when the parameter is stored so as to facilitate selection of image processing parameter (see Japanese Patent Application Laid-Open No. 2004-129226). However, the effect of processing using an image processing parameter cannot be precisely grasped only by parameter name. Especially upon color conversion processing, it is difficult for a user to determine the color and the content of conversion from a parameter name. In such case, the user performs image processing using a stored image processing parameter to finde a desired image processing parameter by trial and error.

### SUMMARY OF THE INVENTION

The present invention has been made in consideration of the above problems, and has its object to enable a user to visually grasp an image processing effect corresponding to an image processing parameter so as to facilitate selection of image processing parameter.

According to one aspect of the present invention, there is provided an information processing apparatus comprising: a generation unit configured to generate a visualized image visually indicating a change content of a color conversion processing in a case that an input image is subjected to a color conversion processing using an image processing parameter set for color conversion of the input image; and a storage unit configured to associate the image processing parameter with the visualized image generated by the generation unit and store them in storage means.

Furthermore, according to another aspect of the present invention, there is provided an information processing method comprising: a generation step of generating a visualized image visually indicating a change content of a color conversion processing in a case that an input image is subjected to a color conversion processing using an image processing parameter set for color conversion of the input image; and a storage step of associating the image processing parameter with the visualized image generated at the generation step and storing them in storage means.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing principal functional constituent elements of an image processing apparatus according to a first embodiment of the present invention;

FIG. 2 is a block diagram showing an arrangement when the image processing apparatus in FIG. 1 is applied to a personal computer;

FIG. 3 is a flowchart showing color conversion definition file generation processing according to the first embodiment;

FIG. 4 illustrates an example of color conversion table according to the first embodiment;

FIG. 5A illustrates a color hue circle as an example of visualized image data;

FIG. 5B is a flowchart showing generation of visualized image data;

FIG. 6 illustrates an example of data structure of a color conversion definition file according to the first embodiment;

FIG. 7 is a flowchart showing image processing using the color conversion definition file according to the first embodiment;

FIG. 8 illustrates an example of data structure of the color conversion definition file when a method 2 or method 3 is used;

FIG. 9 is a block diagram showing the construction of a digital camera 900 according to a second embodiment of the present invention;

FIG. 10 is a perspective view of the outer appearance of the digital camera 900 according to the second embodiment;

FIG. 11 is a flowchart showing an operation of the digital camera in a color conversion mode according to the second embodiment;

FIG. 12 is an explanatory view of color conversion processing using a look-up table according to the second embodiment; and

FIG. 13 is a flowchart showing look-up table reuse processing according to the second embodiment.

### DETAILED DESCRIPTION OF THE PREFERRED EMBODIMENTS

Preferred embodiments of the present invention will now be described in detail in accordance with the accompanying drawings.

### First Embodiment

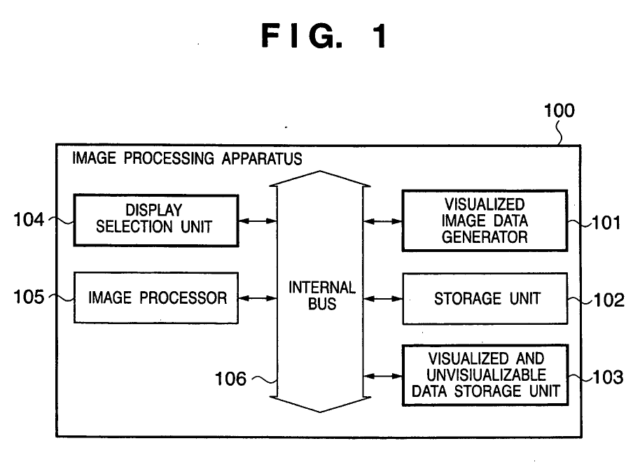

FIG. 1 is a block diagram showing principal functional constituent elements of an image processing apparatus 100 according to a first embodiment of the present invention. In FIG. 1, a visualized image data generator 101 generates image data showing the appearance of image conversion upon image processing using an image processing parameter as invisualizable data. A storage unit 102 is a storage medium for storing image data, visualized image data, invisualizable data (image processing parameter) and other data. A visualized and invisualizable data storage unit 103 associates an image processing parameter with visualized image data and stores the, as e.g. one image file, into a storage unit 103. A display selection unit 104 displays visualized image data associated with at least one image processing parameter (invisualizable data) stored in the storage unit 103 for a user's selection of desired image processing parameter. By the display of visualized image data generated by the visualized image data generator 101, the user can intuitively grasp processing effects by the respective image processing parameters, and can easily select an appropriate image processing parameter. An image processor 105 performs image processing on arbitrary image data using an image processing parameter selected with the display selection unit 104. An internal bus 106 interconnects the above respective constituent elements for mutual data transmission/reception among the respective constituent elements.

In the present embodiment, the image processing apparatus 100 having the above construction is realized using a personal computer (PC).

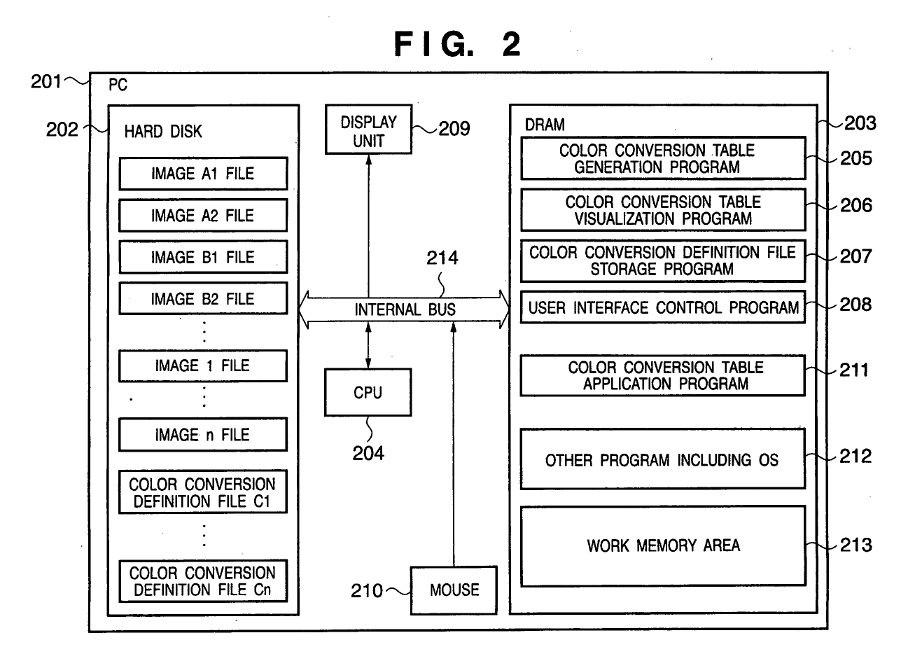

FIG. 2 is a block diagram showing respective functions when the image processing apparatus in FIG. 1 is formed on a PC. Note that, in the following description, a color conversion table for image color conversion processing is employed as an image processing parameter. The other constituent elements not shown in FIG. 2 are the same as those of a general PC.

In FIG. 2, a hard disk 202 holds an image file A1, an image file A2, an image file B1, an image file B2, image 1 to image n files, color conversion definition files C1 to Cn, and other files (not shown). The hard disk constitutes the above storage unit 103. A DRAM (Dynamic Random Access Memory) 203, which is provided in a general PC, holds various programs and data. The respective programs in the DRAM 203 are sequentially executed by a CPU 204, and realize, e.g., the image processing apparatus of the present embodiment as follows.

Color conversion table generation processing, realized by performing a color conversion table generation program 205 by the CPU 204, reads two designated image files, and generates a color conversion table from color difference information between the images. Color conversion table visualization processing, realized by performing a color conversion table visualization program 206 by the CPU 204, generates visualized image data indicating the content of the color conversion table generated by the color conversion table generation processing. Accordingly, the color conversion table visualization program 206 and the CPU 204 constitute the visualized image data generator 101. Color conversion definition file storage processing is realized by performing a color conversion definition file storage program 207 by the CPU 204. The color conversion definition file storage processing stores the color conversion table generated by the color conversion table generation processing and the visualized image data generated by the color conversion table visualization processing as one file into the hard disk 202. Accordingly, the color conversion table visualization program 206 and the CPU 204 constitute the visualized and invisualizable data storage unit 103.

A user interface is provided by performing a user interface control program 208 by the CPU 204. The user interface displays visualized image data included in color conversion definition files C1 to Cn stored in the hard disk 202, in the form of list, on a display unit 209, for the user's selection of visualized image data using a mouse 210. Accordingly, the user interface control program 208, the display unit 209 and the mouse 210 constitute the display selection unit 104. Note that as the display unit 209, a CRT, a liquid crystal display or the like may be used. Further, other pointing devices than the mouse 210 may be used, and further, it may be arranged such that desired visualized image data is selected by key-input.

Color conversion table application processing is realized by performing a color conversion table application program 211 by the CPU 204. The color conversion table application processing reads a color conversion table from a color conversion definition file selected by using the above-described user interface, and performs color conversion processing on an arbitrarily designated image in accordance with the color conversion table. Accordingly, the color conversion table application program 211 and the CPU 204 constitute the image processor 105.

Reference numeral 212 denotes a program such as an operating system which provides basic PC services including file IO and memory management and which is installed in a general PC. A work memory area 213 is an area utilized upon execution of the respective programs by the CPU 204. An internal bus 214 is used for data transmission/reception among the respective blocks in the PC.

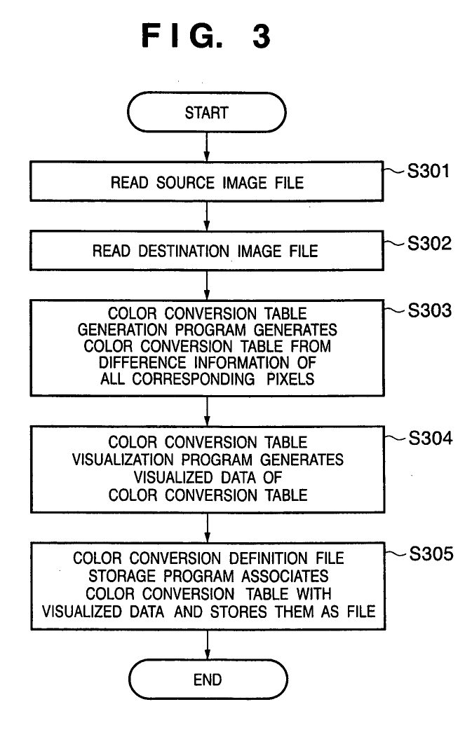

The image processing apparatus (PC) according to the present embodiment, having the above construction as shown in FIG. 2, performs the color conversion definition file generation processing in accordance with the flowchart in FIG. 3.

First, at step S301, a source image file is read into the work memory area 213. In the present embodiment, the user selects an image A1 file as a conversion source image using the mouse 210, and the selected file is read into the work memory area 213. Next, at step S302, a destination image file is read into the work memory area 213. In the present embodiment, the user selects an image A2 file using the mouse 210, and the selected file is read into the work memory area 213. Note that in the present embodiment, the destination image (image A2) has been obtained by previously adjusting the color tone of the source image (image A1) by retouching software and storing the adjusted image as a file.

Next, at step S303, the color conversion table generation processing (205) is performed so as to generate a color conversion table from difference information between corresponding pixels in the same position in the source image (image A1) and the destination image (image A2). As described above, in the present embodiment, an image, obtained by previously adjusting the color tone of the source image (image A1) by retouching software, is stored as the destination image (image A2). Then, a color conversion table is generated from difference information between pixel values in the same position regarding these image data (images A1 and A2).

For example, assuming that image data of sunset glow obtained by image sensing by the user with a digital camera is the image A1. When the image A1 as a result of image sensing has a color different from the user's desired color, the user adjusts the color of e.g. sunset glow to a desired color by retouching software and stores the adjusted image as the image A2. The image A1 and the image A2 are read as a source image and a destination image. In this case, the color conversion table generation processing generates a color conversion table which is preferably applicable to the sunset for the user. Accordingly, when this color conversion table is applied to another sunset image, a sunset image preferable for the user can be easily obtained without retouching work.

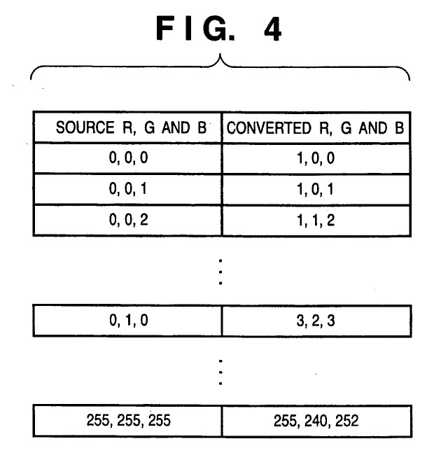

FIG. 4 illustrates an example of the color conversion table. In the color conversion table, input values R, G and B values are indicated in the left column, and color-converted output values (R, G and B) to be outputted in correspondence with the input values are indicated in the right column.

As described above, when the color conversion table as show in FIG. 4 has been generated at step S303, the process proceeds to step S304. At step S304, the color conversion table visualization processing (206) is performed, so as to generate visualized data with which the contents of color conversion table as shown in FIG. 4 can be recognized at a glance. The following [Method 1] to [Method 3] are examples of preferable visualized data generation. However, the visualized data generation is not limited to these methods.

[Method 1] An image where source image data and destination image data (or reduced image data from these data) are arrayed:

as the source image data and destination image data upon generation of color conversion table are arrayed, the user can easily imagine the content of color conversion using the color conversion table.

[Method 2] An image where source image data and color conversion table application result image, obtained by application of the color conversion table to the source image, are arrayed:

as the image resulted from actual application of the table and the source image data are arrayed, the user can easily imagine the content of color conversion using the color conversion table.

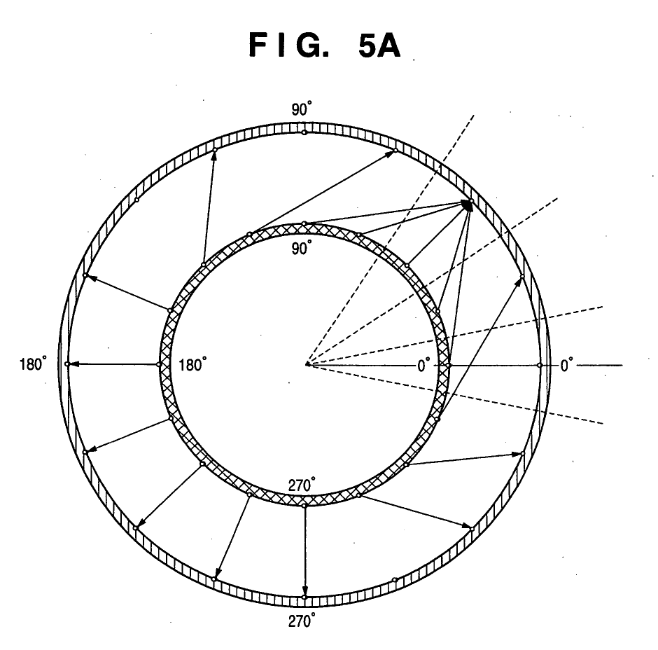

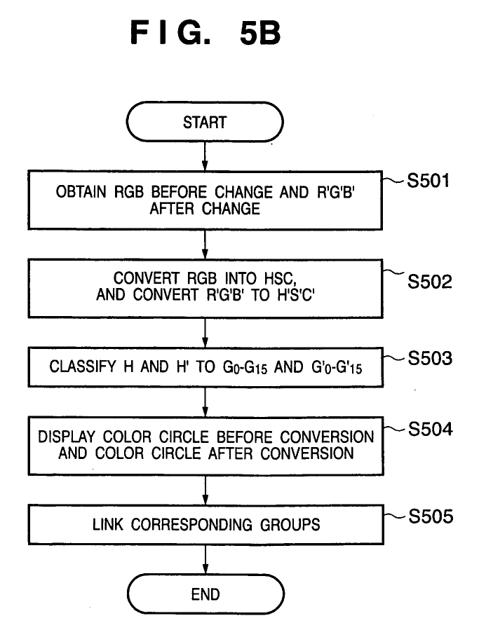

Note that the destination image and the color conversion table application result image do not always correspond with each other in accordance with algorithm of the color conversion table generation program 205. For example, upon scanning of all the pixels of the destination image and the source image and accumulating the difference information, when an algorithm to determine the difference information as noise and not reflect the information in the color conversion table if the number of samples is less than a predetermined number is used, the destination image and the color conversion table application result may not correspond with each other.

[Method 3] An image of color hue circle as shown in FIG. 5A indicating conversion of respective colors by using the color conversion table:

for example, as shown in FIG. 5A, an inner circle shows a color hue circle of color conversion source, and an outer circle, a color hue circle after conversion. Arrows indicate color hues in the outer circle converted by using the color conversion table from respective color hues in the inner circle. The user can check by taking a look at the color hue circle a converted color hue from a color hue by using the color conversion table. In FIG. 5A, a color hue circle using a color conversion table for reddening the color of sunset glow (in the present embodiment, a Munsell (HSC) color hue circle) is used. For example, the user knows by looking at a bold arrow that a color around a color hue 90 degree (yellow) is converted to a color close to red at color hue 45 degree. Note that the expression of color change is not limited to the color hue circle as described above. That is, any method may be used as long as it causes the user to grasp the result of color conversion processing by indicating color change upon execution of color conversion processing using an image processing parameter, by using a color system model or the like.

Note that the color hue circle as shown in FIG. 5A is generated as follows. FIG. 5B is a flowchart showing the generation of the color hue circle in FIG. 5A. First, RGB colors which are changed by conversion, before and after conversion in the color conversion table are converted to color values in HSC color space (steps S501 and S502). Then only regarding color hue (H) value, an unconverted (before conversion) color hue Hₙ is changed to converted color hue H′ₙ (n is a natural number from “1” to number of changed colors). Next, all the values Hₙ are subjected to grouping by a color hue value in a predetermined range (step S503). In FIG. 5A, color hues are grouped as values belonging to any of groups G₀ to G₁₅ obtained by dividing the color hue circle by 22.5 degree. For example, the group G₀ has color values within the 22.5 degree range from 0 degree, i.e., the range from −11.25 degree to +11.25 degree. In this manner, when all the Hn values have been classified, all the H′ₙ values are similarly classified into groups G′₀ to G′₁₅. As a result of above-described grouping, correspondence between the groups having the Hₙ values and the groups having the H′ₙ values is determined. The color hue circle before conversion is indicated as an inner circle 501, and the color circle after conversion is indicated as an outer circle 502 (step S504). Then correspondence between the groups is indicated with an arrow (step S505). Thus, the display as shown in FIG. 5A is produced. For example, the group G₀ corresponds to the group G′₃, and the correspondence is indicated with an arrow.

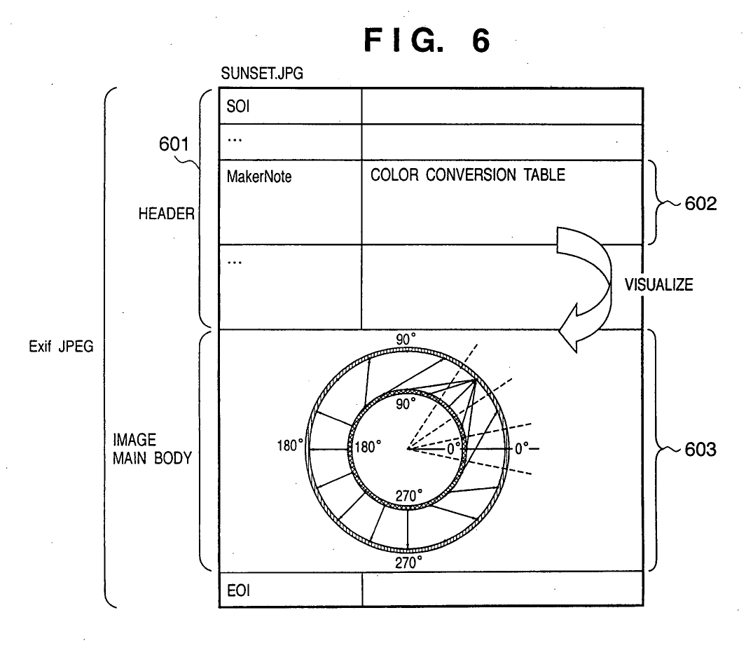

As described above, when the visualized data has been generated at step S304, the process proceeds to step S305. At step S305, the color conversion definition file storage processing (207) is performed. The color conversion table generated at step S303 and the visualized data generated at step S304 are associated with each other, and stored as a color conversion definition file into the hard disk 202. In the present embodiment, as a preferable association method, the color conversion table and the visualized data are stored as one image file as shown in FIG. 6.

Next, an example of the structure of the color conversion definition file will be described with reference to FIG. 6. In the present embodiment, as shown in FIG. 6, the color conversion definition file is an ExifJPEG format file as a general image file format (file name: sunset. JPG). In FIG. 6, various attribute information of image data can be written in a header 601 of the ExifJPEG format. In the present embodiment, the characteristic of the ExifJPEG format is utilized. That is, color conversion table data 602 is stored in a MakerNote area where the data structure is uniquely defined by each vendor, and further, image data obtained by visualizing the color conversion table 602 stored in the MakerNote area is stored as an image main body 603. For example, regarding the sunset. JPG file, image data of color hue circle obtained by visualizing the color conversion table 602 (S304) is stored as the image main body 603.

As shown in FIG. 6, by storing the color conversion definition file in the ExifJPEG format, image data (visualized image of the color conversion table) can be displayed by using general image browser software installed in a PC. Accordingly, the user can check the content of color conversion table and make a selection of color conversion table by using his/her favorite browser software.

As described above, a color conversion definition files Ck including the color conversion definition files C₁ to Cₙ are generated and stored in the hard disk 202 by the color conversion definition file generation processing shown in the flowchart of FIG. 3.

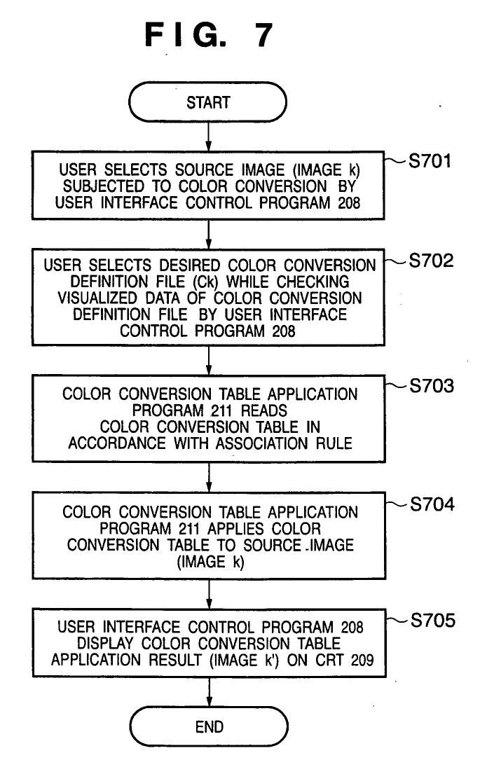

Next, processing upon application of the color conversion definition files C1 to Cn to an arbitrary image will be described with reference to the flowchart of FIG. 7.

First, at step S701, a user interface is provided by execution of the user interface control program 208. That is, images stored in the hard disk 202 are displayed on the display unit 209, and the user selects image data to be subjected to color conversion (image k) among the displayed images (images 1 to n) with the mouse 210 or the like. Next, at step S702, the user interface displays visualized images of the color conversion definition files on the display unit 209 such that the user selects a desired color conversion definition file. For example, visualized images of the color conversion definition files C1 to Cn in the hard disk 202 are displayed on the display unit 209. Note that as this display, plural files may be arrayed as reduced images (for example, thumbnail images) or may be sequentially displayed in original size. The user selects a color conversion definition file (Ck) to be applied to the selected image k among the displayed visualized images of the color conversion definition files with the mouse 210 or the like.

Next, at step S703, the color conversion table application program 211 reads the color conversion table into the work memory area 213 in accordance with the association rule, based on information on the color conversion definition file (Ck). In the present embodiment, the color conversion definition file (Ck) is an ExifJPEG file which has a color conversion table in its header. Accordingly, the program reads the color conversion table from the header of the color conversion definition file (Ck).

Next, at step S704, the color conversion table read into the work memory area 213 is applied to the image k, and an application result image (image k′) is stored into the work memory area 213. Next, at step S705, the user interface control program 208 displays the application result image (image k′) obtained as a result of the application of the color conversion table on the display unit 209. Then, the color conversion definition file application processing shown in FIG. 7 ends.

Note that it is desirable that the application result image (image k′) is stored into the hard disk 202 in accordance with the user's instruction.

As described above, according to the present embodiment, image data obtained by visualizing a color conversion table is generated, and is stored, with the color conversion table, in the ExifJPEG format. As the visualized image data is presented to the user, the user easily selects a color conversion definition file while imagining the result of color conversion, and applies the selected color conversion to an arbitrary image.

Note that in FIG. 6, the [Method 3] is used upon generation of color hue circle. Hereinbelow, the other methods [Method 1] and [Method 2] will be described in detail.

In the [Method 1], image data where source image data (image A1) and destination image data (image A2) upon generation of color conversion table are arrayed is generated as visualized data, and is stored in the ExisfJPEG format. The other constituent elements and processing procedure are the same as those in the above embodiment.

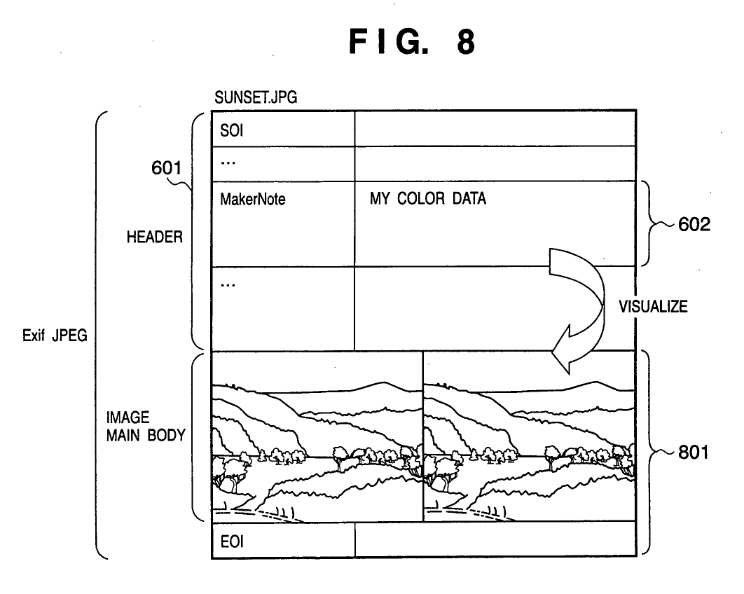

FIG. 8 shows the contents of a color conversion definition file according to the [Method 1]. Numerals 601 and 602 denote the same elements in the color conversion definition file in FIG. 6. In FIG. 8, at step S304 in FIG. 3, the color conversion table visualization processing (206) generates image data where a source image (image A1) and a destination image (image A2) are horizontally arrayed as visualized image data. The generated visualized image data is stored into the image main body 801.

When the visualized image data according to the [Method 1] is used, upon selection of color conversion definition file, a source image (image A1) and a destination image (image A2) upon color conversion table generation are array-displayed. Accordingly, the user can easily imagine the content of color conversion by the color conversion table.

Note that when the image A1 and the image A2 are large in size, it is preferable that visualized image data is generated by using image data obtained by reduction processing on the respective images. For example, as an image having about 320 pixels as its lengthwise size is sufficient to determine color conversion, it is preferable to reduce the source and destination images to about this size as visualized data.

Next, storage of visualized image data according to the [Method 2] will be described. In the [Method 2], data where a source image data (image A1) and a color conversion table application result image (image A1′) as a result of application of a color conversion table to the source image data are arrayed is stored as visualized image data in the ExisJPEG format. The other constituent elements and processing procedure are the same as those in the above [Method 1] and [Method 3].

Further, the content of a color conversion definition file using the [Method 2] is the same as that using the [Method 1] as shown in FIG. 8. In FIG. 8, numerals 601 and 602 denote the same elements in the color conversion definition file in FIG. 6. Note that at step S304 in FIG. 3, the color conversion table visualization processing (206) applies the generated color conversion table to the source image A1 and obtains an application result image (image A1′). Then, the program generates image data where the source image A1 and the application result image A1′ are horizontally arrayed as visualized image data, and stores the data as an image main body 801 in FIG. 8.

As described above, in some color conversion table generation algorithm, the application result image A1′, obtained by application of color conversion table generated from the source image A1 and the destination image A2 to the source image A1, does not always correspond with the destination image A2. In such case, the visualized image data according to the [Method 2] represents the color conversion table more accurately than that in the [method 1].

Note that when the [Method 2] is employed, when the images A1 and A1′ are large in size, it is preferable to use image data obtained by reduction processing on the respective images. For example, as an image having about 320 pixels as its lengthwise size is sufficient to determine color conversion, it is preferable to reduce the source and destination images to about this size as visualized data.

As described above, when the visualized image data according to the [Method 2] is used, the user can easily imagine the content of color conversion by a color conversion table from the source image (image A1) and the application result image (image A1′) upon generation of the color conversion table.

### Second Embodiment

In the above embodiment, a personal computer is used as the image processing apparatus, however, the present invention is also applicable to a digital camera and the like. Hereinbelow, an embodiment where the present invention is applied to a digital camera will be described.

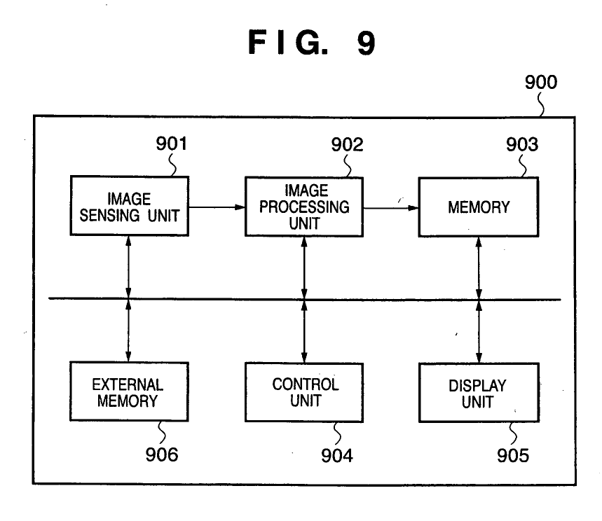

FIG. 9 is a block diagram showing the construction of a digital camera 900 according to the second embodiment of the present invention. In FIG. 9, an image sensing unit 901 having a lens and an image sensing device, converts an optical image formed on an image sensing device surface through the lens into an image signal. An image processing unit 902 performs various processings on the image signal obtained by the image sensing unit 901, and obtains digital image data representing a visualized image. A memory 903 holds various data such as the image data obtained by the image processing unit 902. A control unit 904 realizes operation management and alignment of the above respective elements. A display unit 905 having e.g. a liquid crystal display, is used for image display for an electronic view finder (EVF) and quick view, and menu display for various operations. An external memory 906 is removable storage medium such as compact flash (registered trademark), smart media, a memory stick or the like.

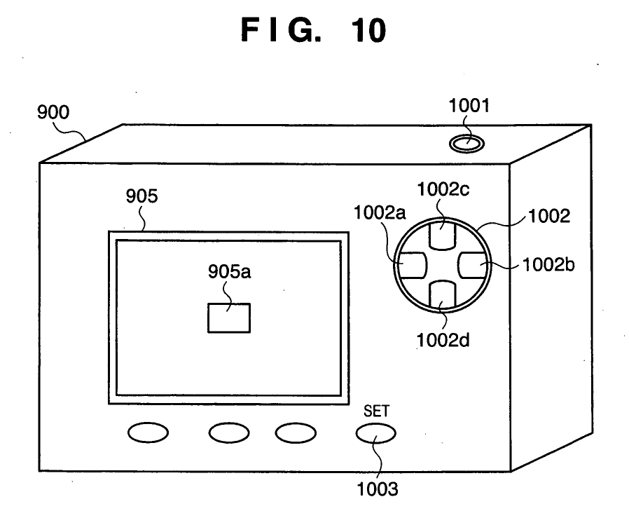

FIG. 10 is a perspective view of the outer appearance of the digital camera 900 according to the second embodiment. As shown in FIG. 10, the digital camera 900 has various operation buttons such as a shutter button 1001, a cross button 1002 and a set button 1003. Note that the cross button 1002 includes a left button 1002a, a right button 1002b, a up button 1002c and a down button 1002d.

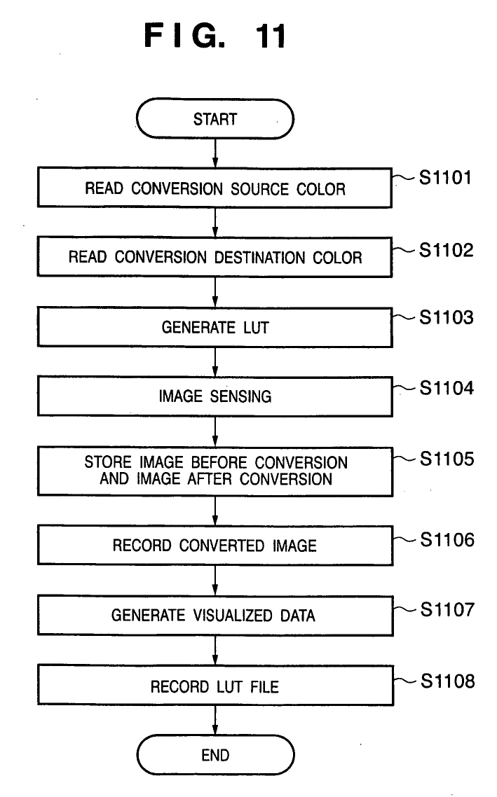

The digital camera 900 according to the present embodiment has an image sensing mode (hereinbelow, referred to as a “color conversion mode”) to enable conversion of a color arbitrarily designated by the user to another color arbitrarily designated by the user. In the color conversion mode, an electronic view finder screen, and at the same time, a color extraction frame 905a, are displayed on the display unit 905. When a predetermined operation is performed so as to set a desired color in the color extraction frame 905a in an image obtained by image sensing and displayed in real time manner on the display unit 905 by the EVF, the color of the image within the color extraction frame 905a is determined as a conversion source color or conversion destination color. When the conversion source color and the conversion destination color have been determined, a look-up table for color conversion processing is set in the image processing unit 902 so as to convert the conversion source color to the conversion destination color. As a result, in the display image in the EVG screen and the image recorded by the operation of the shutter button 1001, the above conversion source color is converted to the conversion destination color. Hereinbelow, the color conversion mode of the present embodiment will be described in detail with reference to the flowchart of FIG. 11.

When the color conversion mode has been set by a predetermined operation of the digital camera 900, then at step S1101, a conversion source color is extracted in correspondence with a predetermined operation. In the present embodiment, in correspondence with depression of the left button 1002a, a mean value of pixels within the color extraction frame 905a in an image displayed on the EVF at that time is determined as the conversion source color. Next, at step S1102, a conversion destination color is extracted in correspondence with a predetermined operation. In the present embodiment, in correspondence with depression of the right button 1002b, a mean value of pixels within the color extraction frame 905a in an image displayed on the EVF at that is determined as the conversion destination color.

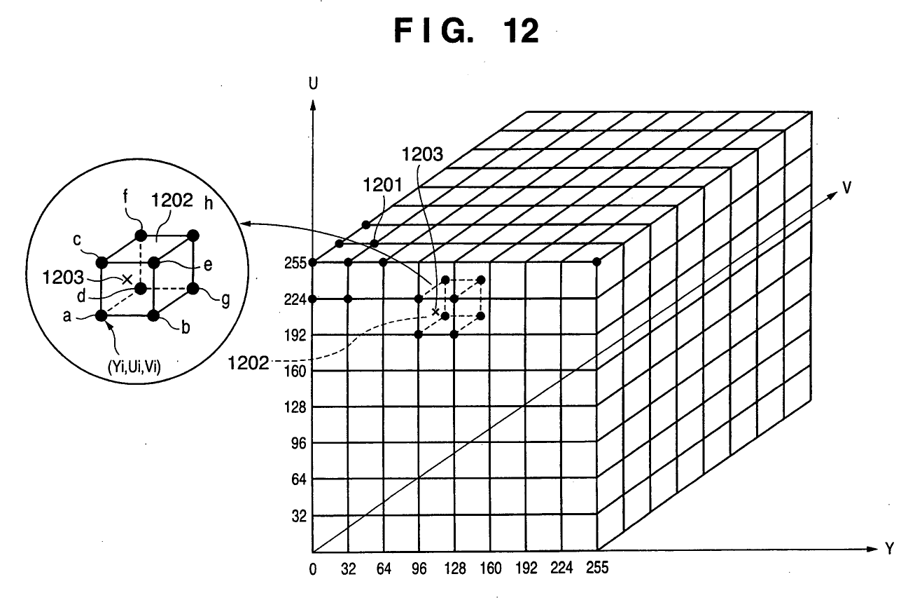

When the conversion source color and the conversion destination color have been determined, then at step S1103, a look-up table to convert the conversion source color to the conversion destination color is generated and set in the image processing unit 902. In the present embodiment, a three-dimensional look-up table as described in the Japanese Patent Application Laid-Open No. 2004-129226 is employed. Hereinbelow, color conversion processing using the look-up table according to the present embodiment will be described with reference to FIG. 12.

FIG. 12 shows the three-dimensional look-up table according to the present embodiment. In the image processing unit 902, YUV is converted to Y′U′V′ by using the three-dimensional look-up table. In the present embodiment, to reduce the capacity of the three-dimensional look-up table, a list (look-up table) of YUV values in 9×9×9=729 three-dimensional representative lattice points obtained by dividing minimum to maximum values of the Y, U and V signals by 8 is used. The YUV signals other than the representative lattice points are obtained by interpolation. FIG. 12 conceptually shows the three-dimensional look-up table according to the present embodiment. In each lattice point, converted YUV values are set. For example, a lattice point 1201 has values (32, 255, 32). When no change occurs before and after the conversion, the values (32, 255, 32) are allocated to the lattice point 1201. Further, when the values of the lattice point 1201 become (32, 230, 28) after the conversion, the values are set in the lattice point 1201.

As described above, when the conversion source color and the conversion destination color have been determined, a cubic lattice including the conversion source color is determined, and the values of the respective lattice points forming the cubic lattice are changed so as to obtain the conversion destination color in the coordinate position of the conversion source color. For example, in FIG. 12, when the determined conversion source color has YUV values in a point 1203, the values in lattice points a to h of the cubic lattice 1202 are changed to convert the YUV values in the point 1203 to YUV values of the set conversion destination color. Although a detailed description will be omitted, values of the representative lattice points after the change are mathematically obtained. In the image processing unit 902, the color conversion processing is performed by using the changed three-dimensional look-up table.

As described above, as the color conversion is performed by determining lattice point data of three-dimensional look-up table based on designated conversion source color and conversion destination color, the user's preferred color setting can be easily applied to a reproduced image.

When the look-up table has been set as described above, the shutter button 1001 is depressed, then image sensing in the color conversion mode is performed (step S1104). In the image sensing, first, at step S1105, an image obtained by image sensing before color conversion and an image obtained by image sensing after the color conversion using the look-up table are stored in the memory 903. Then at step S1106, the image after the color conversion is stored in the external memory 906. Thereafter, at step S1107, visualized image data as described in the first embodiment is generated by using the images before and after the color conversion stored in the memory 903. In the present embodiment, the [Method 2] described in the first embodiment, i.e., generation of visualized image data using before and after conversion (reduced images), is performed. Then at step S1108, the look-up table generated at step S1103 and the visualized image data generated at step S1107 are stored, as one image file, into e.g. the external memory 906.

As described above, the digital camera 900 according to the present embodiment stores the look-up table into the external memory 906. Note that as long as the look-up table is not updated, the processings at steps S1105, S1107 and S1108 are not performed. That is, the processings at steps S1105, S1107 and S1108 are performed only once for a new look-up table, and a file of visualized image data is generated and stored.

Further, as shown in the [Method 3] in the first embodiment and as shown in FIG. 5A and FIG. 6, when representation by color model is employed, an image before conversion is not necessary upon generation of visualized image. Accordingly, in this case, step S1105 can be omitted. Note that as the generation of visualized image by the Method 3 has been described in the first embodiment, the detailed description of the method will be omitted. Note that according to this method, values of lattice points where a change has occurred are converted from the YUV space to the HSC space, then grouping is performed, and a display as shown in FIG. 5A is obtained.

Next, processing for selecting a desired look-up table from the look-up tables stored in the external memory 906, and performing color conversion mode image sensing using the selected look-up table (look-up table reuse processing) will be described.

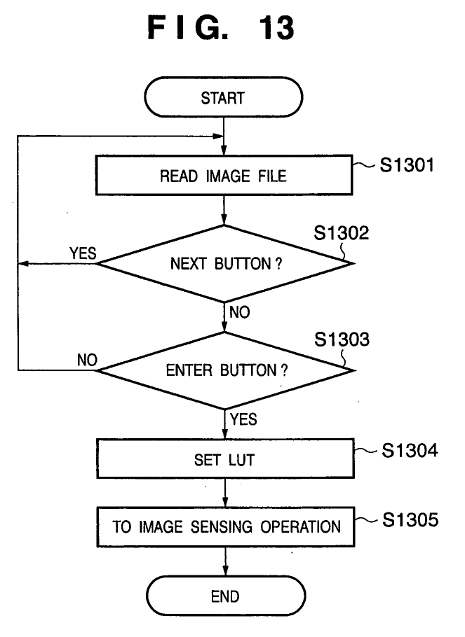

FIG. 13 is a flowchart showing the look-up table reuse processing. When the reuse processing is started by a predetermined operation, then at step S1301, image files of visualized image data stored in the external memory 906 are read and the images are displayed on the display unit 905. Note that file names or the like of the image file holding the visualized image data are set such that these files can be discriminated from general image files obtained by image sensing. Further, the content of visualized image data is displayed as e.g. a reduced image (thumbnail image or the like) on the display unit 905. The visualized images are sequentially displayed on the display unit 905 by operation of the up button 1002c and the down button 1002d (step S1302). When a visualized image for execution of desired color conversion is displayed on the display unit 906, the set button 1003 is depressed. The processing proceeds from step S1303 to step S1304 in correspondence with the depression of the set button, and a look-up table held in the header of the visualized image data file displayed at that time is set in the image processing unit 902. Thereafter, when the shutter button 1001 is depressed, image sensing in the color conversion mode is performed (as in the case of step S1104). In this case, as the existing look-up table is used, the processing to store visualized image data as an image file is not performed.

As described above, according to the respective embodiments, visualized image data is generated from a color conversion table such that the user imagine the result of color conversion by using the color conversion table. Then the color conversion table and the visualized image data are stored and managed, in the EXIF data format, as a general image file similar to that obtained by image sensing. As a result, the characteristic of the color conversion table (color conversion processing state) can be held and presented in visible form. More particularly, numeric data of the color conversion table is stored in the header, and image data representing the content and characteristic of the table is stored in the image data main body, thereby the content of the table can be visualized.

According to the above embodiments, when the user performs image processing on an arbitrary image, the user can determine an image processing parameter while referring to visualized image data representing the content of image processing. Accordingly, the user can easily imagine the results of application of various image processing parameters, and can easily obtain an expected result of image processing.

Note that the above embodiments have been described regarding the color conversion processing parameters, however, the present invention is applicable to other image processing parameters. In such case, the [Method 2] for example is applied, thereby images obtained by image sensing, before and after image processing, are recorded in a file as visible data.

In addition to the above-described embodiments, the present invention provides embodiments as a system, an apparatus, a method, a program or storage medium and the like. More particularly, the invention is applicable to a system constituted by plural devices or to an apparatus comprising a single device.

The present invention can be applied to a system constituted by a plurality of devices or to an apparatus comprising a single device.

Note that the object of the present invention can also be achieved by providing a software program (in the embodiments, the programs corresponding to the figures) for performing the above-described functions of the embodiments directly or remotely to a system or an apparatus, reading the program code with a computer of the system or apparatus then executing the program.

Accordingly, to realize the functional processings of the present invention with a computer, the program code installed in the computer itself realizes the present invention. That is, the present invention includes the computer programs to realize the functional processing of the present invention.

In this case, as long as the system or apparatus has the functions of the program, the program may be executed in any form, such as an object code, a program executed by an interpreter, or script data supplied to an OS.

Further, the storage medium, such as a floppy (registered trademark) disk, a hard disk, an optical disk, a magneto-optical disk, an MO, a CD-ROM, a CD-R, a CD-RW, a magnetic tape, a non-volatile type memory card, a ROM and a DVD (DVD-ROM and a DVD-R) can be used for providing the program code.

As for the method of supplying the program, a client computer can be connected to a website on the Internet using a browser of the client computer, and the computer program of the present invention or an automatically-installable compressed file of the program can be downloaded from the website to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the above-described functions according to the embodiments are realized by executing the program code which is read by a computer, the present invention includes a case where an OS or the like working on the computer performs a part or entire actual processing in accordance with designations of the program code and realizes functions according to the above embodiments.

Furthermore, the present invention also includes a case where, after the program code read from the storage medium is written in a function expansion card which is inserted into the computer or in a memory provided in a function expansion unit which is connected to the computer, CPU or the like contained in the function expansion card or unit performs a part or entire process in accordance with designations of the program code and realizes functions of the above embodiment/embodiments.

As described above, according to the present invention, it is possible to visually grasp an image processing effect corresponding to an image processing parameter and easily select an image processing parameter.

As many apparently widely different embodiments of the present invention can be made without departing from the spirit and scope thereof, it is to be understood that the invention is not limited to the specific embodiments thereof except as defined in the appended claims.

This application claims the benefit of Japanese Patent Application No. 2005-112656, filed Apr. 8, 2005, which is hereby incorporated by reference herein in its entirety.

What is claimed is:

1. An information processing apparatus comprising:
a generation unit configured to generate a visualized image visually indicating a change content of a color conversion processing in a case that an input image is subjected to a color conversion processing using an image processing parameter set for color conversion of the input image; and
a storage unit configured to associate said image processing parameter with the visualized image generated by said generation unit and store them in storage means.

2. The apparatus according to claim 1, further comprising:
a display unit configured to display the visualized image stored by said storage unit;
an acquisition unit configured to acquire the image processing parameter associated with the visualized image selected from visualized images displayed by said display unit; and
a processing unit configured to perform processing on an image using the image processing parameter acquired by said acquisition unit.

3. The apparatus according to claim 1, wherein said generation unit generates an image, representing a change of color upon execution of the color conversion processing using said image processing parameter by a color system model, as said visualized image.

4. The apparatus according to claim 1, wherein said image processing parameter is acquired based on a conversion source image and a conversion destination image,
and wherein said generation unit generates said visualized image using said conversion source image and said conversion destination image.

5. The apparatus according to claim 4, wherein said generation unit generates said visualized image where reduced images of said conversion source image and said conversion destination image are arrayed.

6. The apparatus according to claim 1, wherein said generation unit generates said visualized image using an image where reduced images of images before and after image processing using said image processing parameter are arrayed.

7. The apparatus according to claim 1, wherein said storage unit generates one file where said image processing parameter and said visualized image are recorded in a predetermined format and stores the file into said storage means.

8. The apparatus according to claim 1, wherein said storage unit generates a file where said image processing parameter and information specifying said visualized image data are recorded and stores the file into said storage means.

9. An information processing method comprising:
a generation step of generating a visualized image visually indicating a change content of a color conversion processing in a case that an input image is subjected to a color conversion processing using an image processing parameter set for color conversion of the input image; and
a storage step of associating said image processing parameter with the visualized image generated at said generation step and storing them in storage means.

10. The method according to claim 9, further comprising:
a display step of displaying the visualized image stored at said storage step;
an acquisition step of acquiring the image processing parameter associated with the visualized image selected from visualized images displayed at said display step; and
a processing step of perform processing on an image using the image processing parameter acquired at said acquisition step.

11. The method according claim 9, wherein at said generation step, an image, representing a change of color upon execution of the color conversion processing using said image processing parameter by a color system model, is generated as said visualized image.

12. The method according to claim 9, wherein said image processing parameter is acquired based on a conversion source image and a conversion destination image,
and wherein at said generation step, said visualized image is generated by using said conversion source image and said conversion destination image.

13. The method according to claim 9, wherein at said generation step, said visualized image where reduced images of images before and after image processing using said image processing parameter are arrayed is generated.

14. The method according to claim 13, wherein at said generation step, said visualized image where reduced images of said conversion source image and said conversion destination image are arrayed is generated.

15. The method according to claim 9, wherein at said storage step, one file where said image processing parameter and said visualized image are recorded in a predetermined format is generated and stored into said storage means.

16. The method according to claim 9, wherein at said storage step, a file where said image processing parameter and information specifying said visualized image data are recorded is generated and stored into said storage means.

17. A control program for performing the information processing method in claim 9 by a computer.

18. A storage medium holding a control program for performing the information processing method in claim 9 by a computer.
